(19) United States
(12) Patent Application Publication
(10) Pub. No.: US 2019/0074610 A1
(43) Pub. Date: Mar. 7, 2019

(54) COAXIAL CABLE CONNECTOR WITH GROUNDING COUPLING NUT

(71) Applicant: Amphenol Corporation, Wallingford, CT (US)

(72) Inventors: Rakesh Thakare, Cary, NC (US); Weixing Chen, Changzhou (CN); Caichun Song, Changzhou (CN)

(21) Appl. No.: 16/111,993

(22) Filed: Aug. 24, 2018

Related U.S. Application Data
(60) Provisional application No. 62/553,539, filed on Sep. 1, 2017.

(51) Int. Cl. H01R 9/05; H01R 13/622

(52) U.S. Cl. CPC H01R 9/0527; H01R 13/622; H01R 9/0521

(57) ABSTRACT

A coaxial cable connector that has a connector body, a post configured to terminate a cable, and a coupling nut with a first inner section near or at the front end and a second inner section behind the first inner section. Both of the first and second inner sections being configured to engage the mating port. Grounding member is positioned on an inner surface of the coupling nut at the first inner section and is configured for electrical connection to the mating port proving a grounding path therebetween therebetween.

### RELATED APPLICATION

This application claims the priority to U.S. Provisional Application No. 62/553,539, filed Sep. 1, 2017, the subject matter of which is herein incorporated by reference.

### FIELD OF THE INVENTION

The present invention relates to a coaxial cable connector with a coupling nut that is designed to ensure a positive mating connection with a mating connector, port or equipment, while also providing improved grounding and shielding to the connector.

### BACKGROUND

Coaxial cable connectors are typically used to connect a coaxial cable with a mating connector, port or terminal of another device, such as equipment, appliances, and the like. Conventional cable connectors are disclosed, for example, in U.S. Pat. Nos. 8,231,412, 7,618,276, 7,544,094, and 7,189,091, the subject matter of each of which is herein incorporated by reference. Proper connection of the coaxial cable connector and its mating connector or port is required to maintain a positive electrical connection and maximize electrical performance.

Therefore, a need exists for coaxial cable connector that facilitates the proper connection of the coaxial cable connector to a mating connector or port and also provides protection against signal leakage and reduces any noise generated during installation to maximize electrical performance of the assembly.

### SUMMARY OF THE INVENTION

Accordingly, the present invention may provide a coaxial cable connector that comprises a connector body, a post received at least partially in the connector body, the post being configured to terminate a cable, and a coupling nut. The coupling nut has a front end for interfacing with a mating port, an opposite rear end rotatably coupled to the post, and first and second inner sections therebetween where the first inner section is near or at the front end and the second inner section is behind the first inner section. Both of the first and second inner sections are configured to engage the mating port. A grounding member is positioned on an inner surface of the coupling nut at the first inner section that is configured for electrical connection to the mating port, thereby establishing a grounding contact and path therebetween. In a preferred embodiment, the grounding member makes immediate grounding contact with the mating port even before the pin conductor of the cable (terminated by the coaxial cable connector) makes any contact with the mating signal carrying contact of the mating port. The grounding member may also provide shielding against signal leakage.

In some embodiments, the first inner section is configured for a push-on engagement with the mating port and the second inner section is configured for a threaded engagement with the mating port; the second inner section includes threads on the inner surface of the coupling nut for threadably engaging the mating port; and/or the second inner section includes around three more or less threads.

In other embodiments, the grounding member is a conductive spring member with radial flexibility that is configured to provide a friction fit when engaging the mating port; the conductive spring member is a spring strip positioned along the inner surface of the coupling nut at the first inner section forming a generally ring shape; the conductive spring strip has inner and outer faces and comprises at least one contact point on the inner face of the spring strip for contacting a conductive surface of the mating port; the conductive spring strip comprises at least one beam extending between frame ends, the at least one beam having the at least one contact point; the conductive spring strip comprises a plurality of beams extending between the frame ends and a plurality of contact points, each of the beams having at least one of the plurality of contact points; the at least one beam has a concave shape curving away from the inner surface of the coupling nut; the at least one beam has one or more concave portions extending inwardly away from the inner surface of the coupling nut, each of the one or more concave portions having at least one of the contact points; wherein the at least one beam is substantially straight and inset from the frame ends of the conductive spring strip; and/or the at least one contact point defines a contact surface for engaging the mating port.

In one embodiment, the front end of the coupling nut includes an annular lip and the spring strip is captured between the annular lip and a first thread of the threads of the second inner section.

The present invention may also provide a coaxial cable connector that comprises a connector body, a post received at least partially in the connector body, the post being configured to terminate a cable a and a coupling nut. The coupling nut has a front end for interfacing with a mating port, an opposite rear end rotatably coupled to the post, and first and second inner sections therebetween. The first inner section is near or at the front end and configured to push onto the mating port and has a grounding member for providing an electrical connection grounding with an outer surface of the mating port, thereby establishing a grounding path and contact therebetween when the coupling nut is pushed onto the mating port. The second inner section is behind the first inner section and configured to threadably engage the mating port. The shielding member is a conductive spring member with radial flexibility that is configured to provide a friction fit when the coupling nut is pushed onto the mating port.

In certain embodiments, the conductive spring member is a spring strip positioned along the inner surface of the coupling nut at the first inner section forming a generally ring shape and has inner and outer faces and comprises at least one contact point on the inner face of the spring strip for contacting a conductive surface of the mating port; the conductive spring strip comprises at least one beam extending between frame ends, the at least one beam having the at least one contact point; the at least one beam has a concave shape curving away from the inner surface of the coupling nut; the at least one beam has one or more concave portions extending inwardly away from the inner surface of the coupling nut, each of the one or more concave portions having at least one of the contact points; and/or the at least one beam is substantially straight and inset from the frame ends of the conductive spring strip.

In some embodiments, the second inner section includes three threads; a spring is disposed between the coupling nut and the post, the spring being configured to compress in a longitudinal direction when the second inner section is threaded onto the mating port; a conductive touch component is received in the coupling nut, and the spring being positioned to bias the conductive touch component in a mating direction toward the first inner section of the coupling nut; the conductive touch component includes a mating port contact surface at one end for contacting the mating port when the coupling nut is pushed onto the mating port; and/or the spring is positioned either outside of the post adjacent to an end of the post or inside of the end of the post.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawing figures:

FIG. 1 is a perspective view of a coaxial cable connector according to an exemplary embodiment of the present invention;

FIG. 2 is a cross-sectional view of the coaxial cable connector illustrated in FIG. 1;

FIG. 3 is a perspective view of an exemplary grounding member of the coaxial cable connector illustrated in FIG. 1;

FIGS. 4A and 4B are cross-sectional views of the coaxial cable connector illustrated in FIG. 1, showing the connector before and after connection, respectively, to a mating connector;

FIG. 5 is a perspective view of another exemplary grounding member according to the present invention;

FIGS. 6A and 6B are cross-sectional views of the coaxial cable connector with the grounding member illustrated in FIG. 5, showing the connector before and after connection, respectively, with a mating connector;

FIG. 7 is a perspective view of yet another exemplary grounding member according to the present invention;

FIGS. 8A and 8B are cross-sectional views of the coaxial cable connector with the grounding member illustrated in FIG. 7, showing the connector before and after connection, respectively, with a mating connector;

FIG. 9 is a cross-sectional view of a coaxial cable connector according to another exemplary embodiment of the present invention; and

FIG. 10 is a cross-sectional view of a coaxial cable connector according to yet another exemplary embodiment of the present invention.

### DETAILED DESCRIPTION

Referring to the figures, the present invention relates to exemplary embodiments of a coaxial cable connector 100 with a coupling nut 110 that is designed to provide improved grounding and protection against signal leaking between the connector 100 and its mating connector or, port 10. The coaxial cable connector 100 of each embodiment is preferably configured to both push-on and threadably engage the mating port 10 to provide a positive electrical and mechanical coupling therebetween and facilitate shielding and grounding.

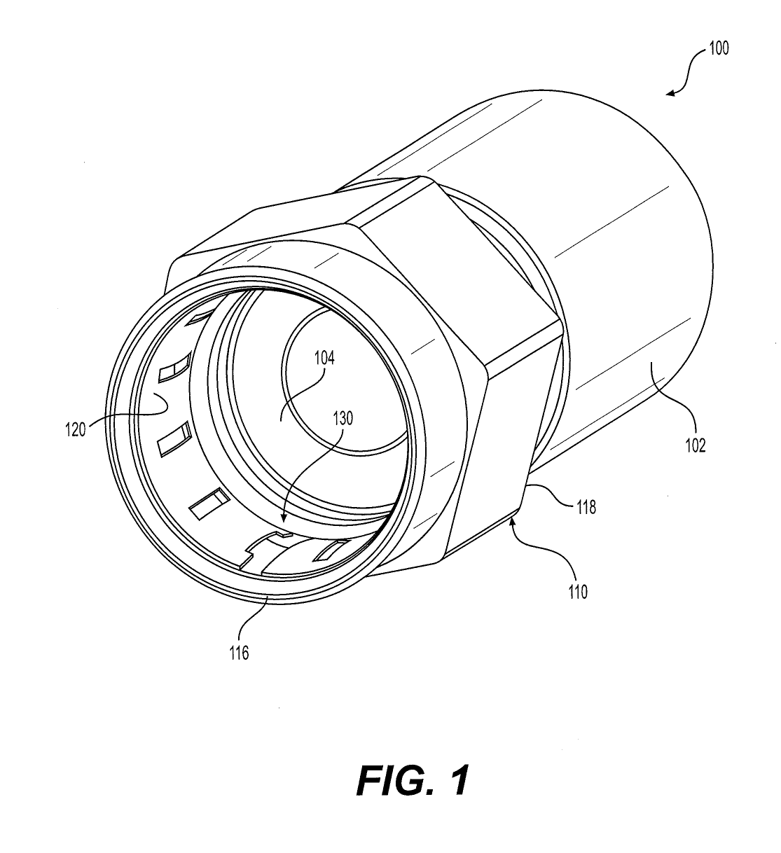

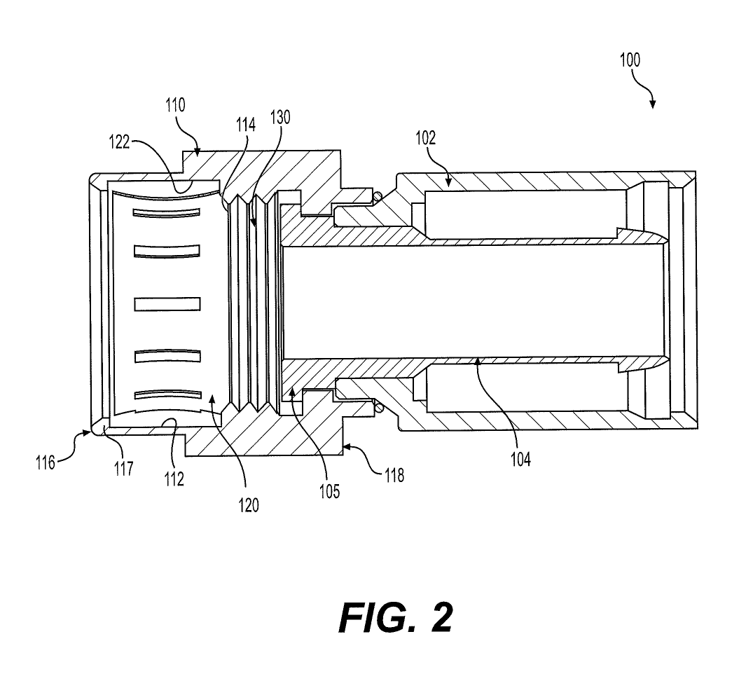

FIGS. 1 and 2 illustrate a coaxial cable connector 100 in accordance with an exemplary embodiment of the present invention. Connector 100 may generally include a connector body 102, a post 104 received at least partially in the body 102 and that is configured to terminate a cable, and a coupling nut 110 rotatably coupled to the post 104 for mating the connector 100 to its mating port, as is known in the art. Post 104 preferably has the same structure as posts of conventional coaxial cable connectors. An optional gripping sleeve may be provided on connector 100, such as the sleeve disclosed in commonly owned U.S. Design application No. 29/643,798, the subject matter of which is herein incorporated by reference.

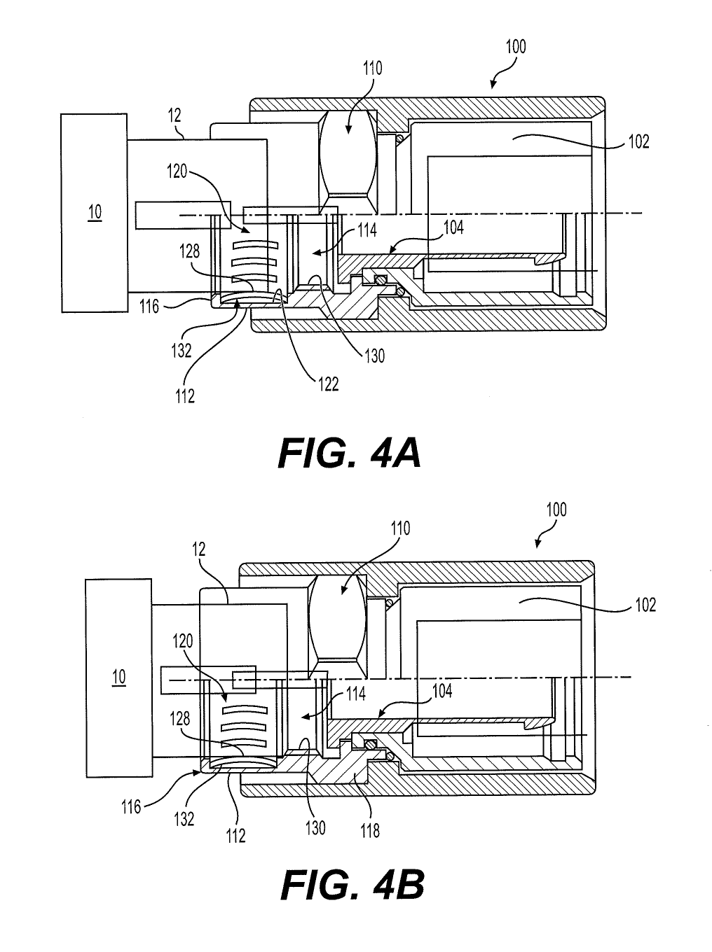

Nut 110 may be a hybrid push/turn coupler that may include first and second inner sections 112 and 114 disposed between front and rear ends 116 and 118 of nut 110, as seen in FIGS. 1 and 2. The first inner section 112 is configured primarily to electrically engage the mating port 10 and establish a grounding path and immediate grounding contact therebetween, even prior to the mating contacts of the cable and the mating port connect. The second inner section 114 is configured primarily to mechanically engage the mating port 10. First inner section 112, however, also secondarily provides a mechanical connection to mating port 10 and second inner section 114 secondarily provides an electrical connection to mating port 10. In a preferred embodiment, first inner section 112 may be designed for a push-on engagement, that is to push onto the mating port 10 for an electrical and frictional engagement with a conductive outer portion or surface of the mating port 10; and second inner section 114 may be designed to thread onto the mating port to threadably engage the same, as seen in FIG. 4B. The first inner section 112 is generally at or near the front end 116 of the connector 100 which interfaces with the mating port 10 and the second inner section 114 is generally behind first inner section 112. In one embodiment, the second inner section 114 may comprises several inner threads 130, such as about three threads, as seen in FIG. 2. The rear end 118 of the nut 110 is rotatably coupled to the end 105 of the post 104.

First inner section 112 may include a grounding member 120, such as a conductive spring member, that preferably has radial flexibility to facilitate the push-on and electrical connection with the mating port 10, as seen in FIGS. 4A and 4B. Grounding member 120 may be positioned inside of the first inner section 112 near the front interface end 116 of the nut 110, as seen in FIGS. 1 and 2. Second inner section 114 of nut 110 may include threads 130 for threadably engaging the mating port 10. Thus, after the nut 110 is pushed onto the mating port 10, the connector 100 may be further and positively secured to the mating port 10 by threading the threads 130 onto the mating port 10. Threads 130 are preferably disposed on an inner surface 122 of the nut 110 at second inner section 114. In a certain embodiment, threads 130 include two or three threads located behind grounding member 120.

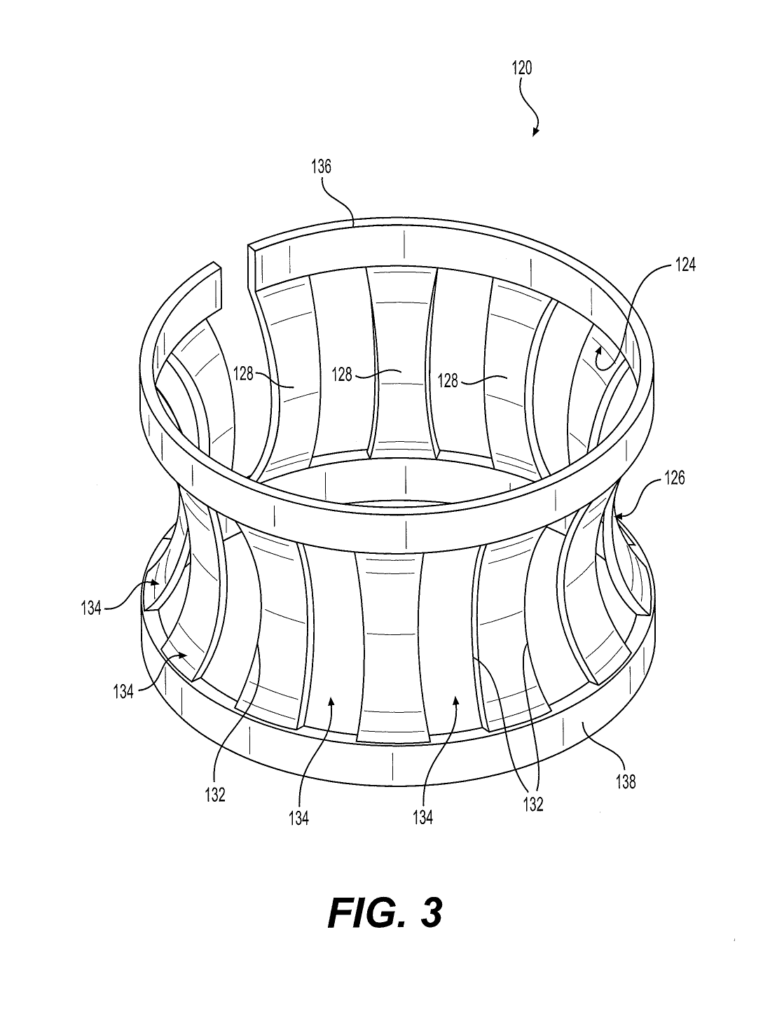

In one embodiment, the grounding member 120 may be a conductive spring strip that is disposed along the inner surface 122 of nut 110 at the first inner section 112. The front end 116 of nut 110 may include an annular lip 117 (FIG. 2) such that the spring strip 120 is captured between the lip 117 and the first thread of threads 130 behind the spring strip at the second inner section 114. The spring strip 120 may extend substantially continuously around the inner surface 122 of nut 110 at or near the front end 116 thereof, thereby forming a generally ring shape, as seen in FIG. 3. The spring strip 120 is preferably shaped to have radial flexibility so that it can flex in a radial direction and engage the mating port 10 in a friction fit. Due to the shape and conductive nature of the spring strip 120, it provides grounding before the center conductor of the cable meets mating contact of the mating port and provides protection against signal leakage even when connector 100 has only been pushed onto the mating port 10 and not fully threaded onto the mating port 10.

The spring strip 120 may have inner and outer faces 124 and 126 and comprise at least one contact point 128 on its inner face 124, as best seen in FIG. 3, for contacting a conductive surface 12 of the mating port 10. The spring strip 120 has at least one concave portion 132 for resiliently engaging the mating port 10 when the nut 100 is pushed thereon. In a preferred embodiment, the spring strip 120 comprises one or more beams 134 extending between opposite frame ends 136 and 138 and each beam 134 is substantially concaved inwardly defining the concave portion 132 and providing the contact point 128 on the inner face 124 thereof. The beams 134 may be uniformly spaced, as shown in FIG. 3, or non-uniformly spaced. The beams 134 may be substantially the same size and shape, as shown in FIG. 3, or the beams 134 may have different sizes and shapes. In a preferred embodiment, the spring strip 120 is formed by stamping a curved strip from a conductive metal with slots formed therein to define the beams 134 and the frame ends 136 and 138.

FIGS. 4A and 4B illustrate the mating of connector 100, that has grounding member 120, with the mating port 10. FIG. 4A shows the front end 116 of nut 110 pushed onto the mating port 10 and the initial contact between the grounding member 120, and particularly its concave portion 132 of one or more of the beams 134, with the conductive surface 12 of the mating port 10. As seen in FIG. 4A, the concave portion 132 curves or concaves inwardly away from the inner surface 122 of nut 110. At this point, immediate grounding contact is made and thus establishing a grounding path between the conductive surface 12 of the mating port 10 and the contact points 128 of the grounding member 120 of connector 100, even before the connector 100 is fully mated to port 10. That is surface 12 of mating port 10 and contact points 128 of grounding member 120 provide the grounding before the cable's center conductor) and mating contact of the mating port are connected. FIG. 4B shows connector 100 fully mated with port 10, that is the first inner section 112 of nut 110 both electrically and frictionally engages the mating port 10 and the second inner section 114 threadably engages the port 10 for a secure mechanical connection thereto.

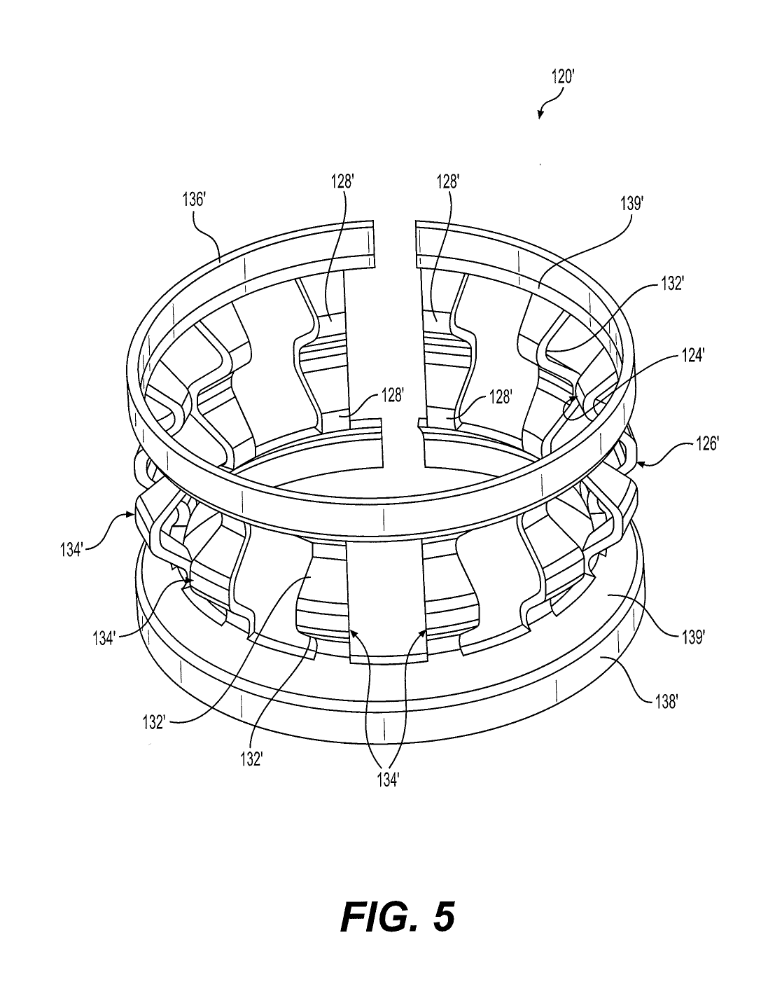

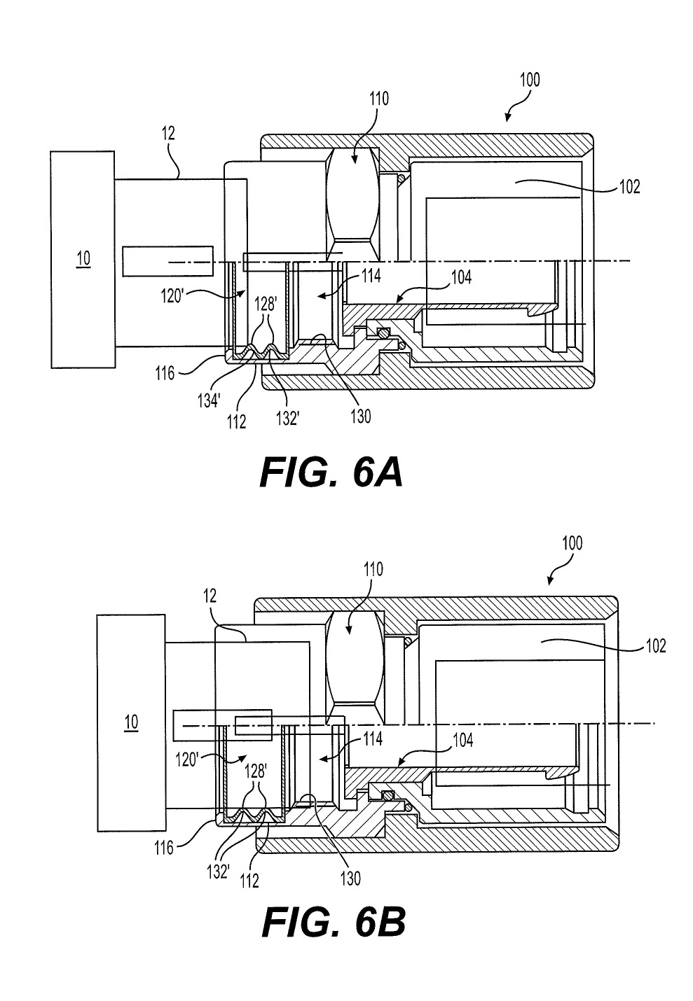

FIG. 5 illustrates a grounding member 120′ in accordance with another exemplary embodiment of the present invention. The grounding member 120′ is positioned in nut 110 and used for grounding between connector 100 and port 10 in the same manner as the grounding member 120, as seen in FIGS. 6A and 6B. Grounding member 120′ may be a spring strip with beams 134′ formed into a generally ring shape, like the grounding member 120. Each beam 134′ of grounding member 120′ preferably includes a plurality of concave portions 132′, thereby defining more than one contact point 128′ on the inner face 124′ thereof. As such, the beams 134′ have a generally corrugated shape, as best seen in FIG. 6A. In addition, the frame ends 136′ and 138′, between which the beams 134′ extend, may each have an inner lip extension 139′ that connects with the respective ends of the beams 134′ such that beams 134′ are slightly inset.

FIG. 6A shows the front end 116 of nut 110 pushed onto the mating port 10 and the contact between the grounding member 120′, and particularly the contact points 128′ of concave portions 132′ of the beams 134′, with the conductive surface 12 of the mating port 10 to establish the initial electrical connection, and thus immediate grounding between the conductive surface 12 of the mating port 10 and grounding member 120′ of connector 100. FIG. 6B shows connector 100 with grounding member 120′ fully mated with port 10, that is the first inner section 112 of nut 110 both electrically and frictionally engages the mating port 10 and the second inner section 114 threadably engages the port 10 for a secure mechanical connection thereto.

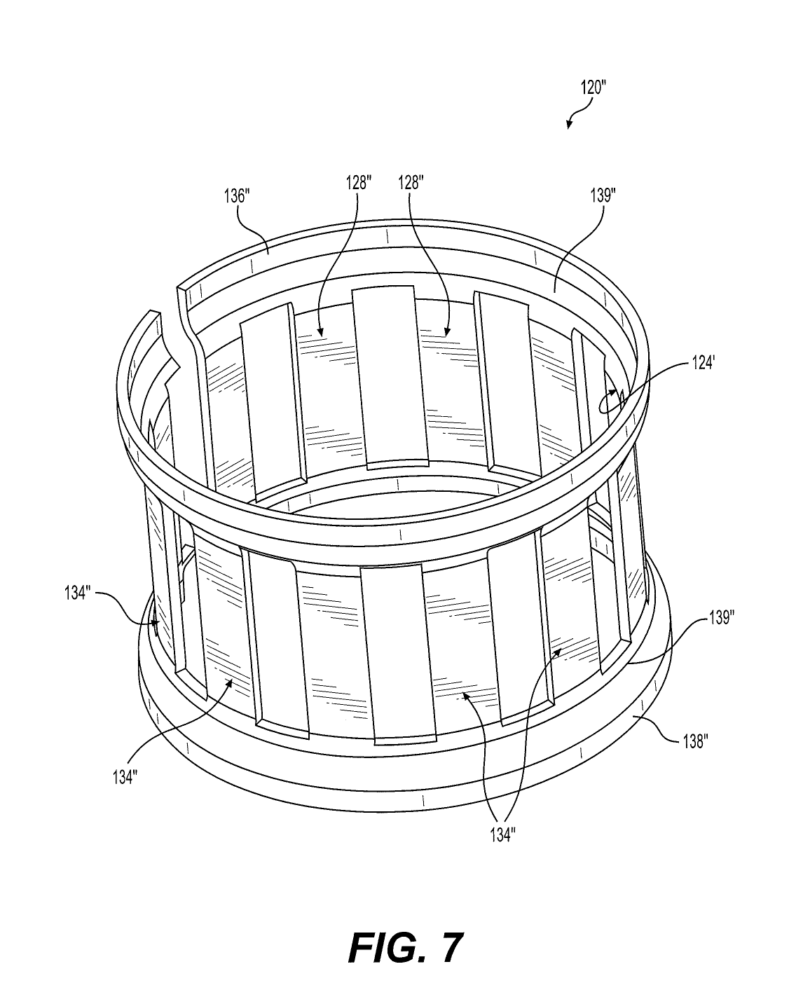

FIG. 7 illustrates a grounding member 120″ in accordance with yet another exemplary embodiment of the present invention. Grounding member 120″ is similar to the grounding members 120 and 120′, except that its beams 134″ are generally flat and straight. The beams 134″ may also be inset from the frame ends 136″ and 138″ via an inward lip extension 139″. Being generally flat rather than concave, the contact point 128″ of each beam 134″ defines a contact surface on the inner face 124″ of the grounding member 120″.

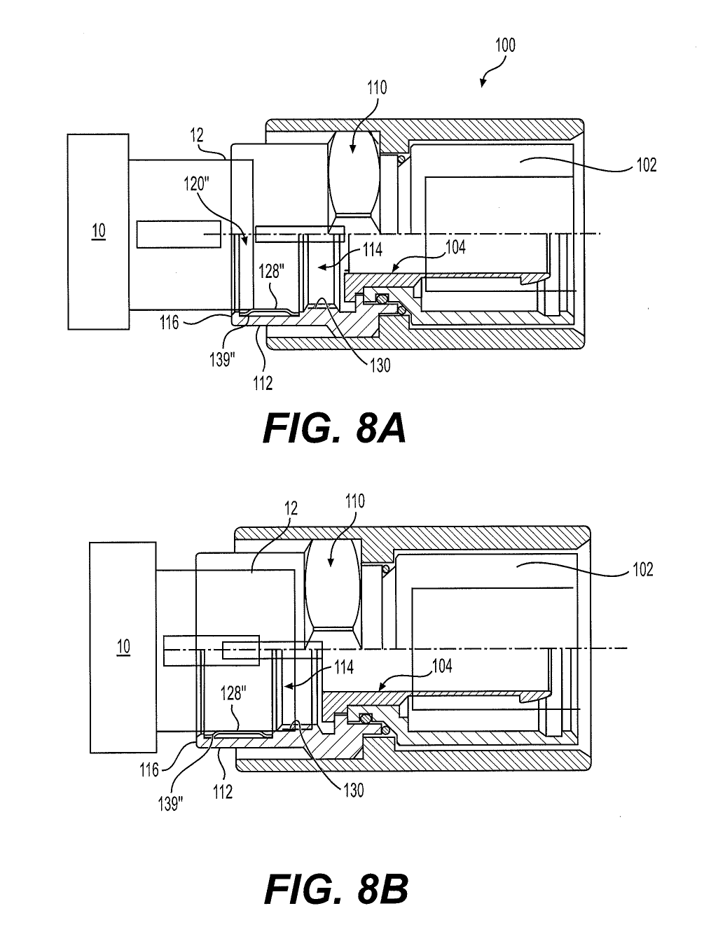

FIG. 8A shows the front end 116 of nut 110 pushed onto the mating port 10 and the contact between the grounding member 120′, and particularly the contact surface 128″ of each beams 134″, with the conductive surface 12 of the mating port 10 to establish the initial electrical connection, and thus immediate grounding between the conductive surface 12 of the mating port 10 and grounding member 120″ of connector 100. FIG. 8B shows connector 100 with grounding member 120″ fully mated with port 10, that is the first inner section 112 of nut 110 both electrically and frictionally engages the mating port 10 and the second inner section 114 threadably engages the port 10 for a secure mechanical connection thereto.

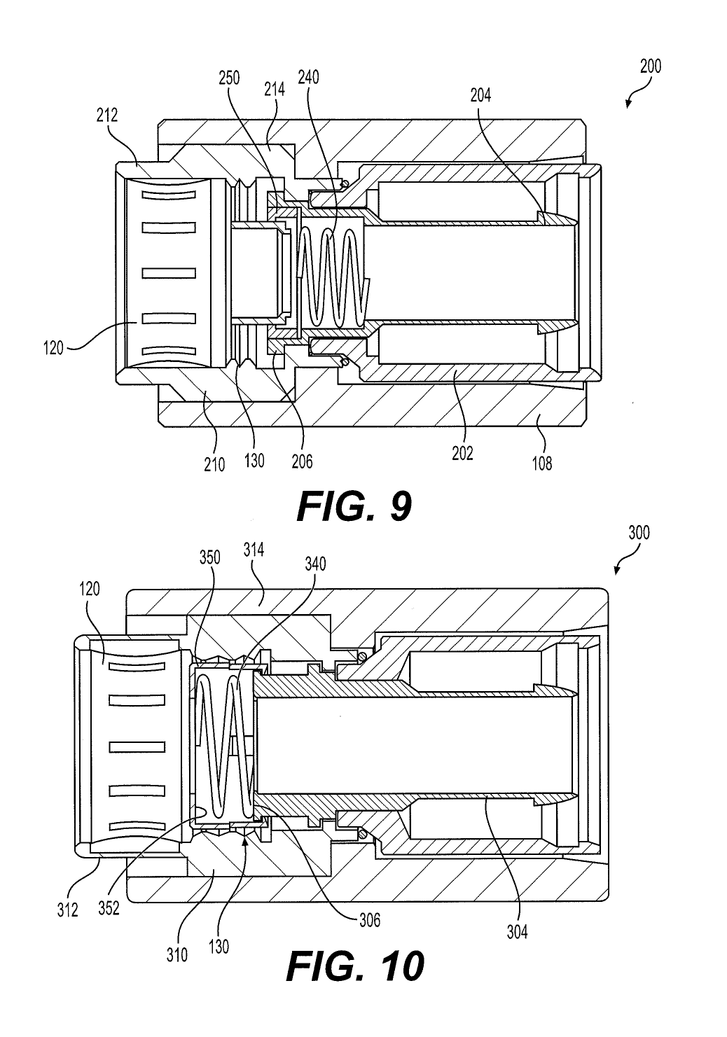

FIG. 9 illustrates a coaxial cable connector 200 in accordance with another exemplary embodiment of the present invention. Connector 200 is similar to connector 100, except that is also includes a spring 240 disposed between the nut and post to provide increased grounding and shielding when connector 200 is coupled to the mating port.

Like the connector 100, connector 200 of the second embodiment may have a connector body 202, a post 204 received at least partially in the body 202, and a coupling nut 210 rotatably coupled to the post 204. Nut 210 preferably has a similar design to nut 110 in that it includes first and second inner sections 212 and 214 for engaging the mating port 10 in the same manner as discussed above where the first inner section 212 includes the grounding member 120 and the second inner section 214 includes the internal threads 130.

Spring 240 may be positioned inside of the end 206 of post 204. A conductive touch component 250 may be positioned generally adjacent to spring 240 such that spring 240 can apply a biasing force to touch component 250 when connector 200 is pushed onto the mating port. The touch component 250 contacts the mating port 10, and a conductive surface thereof, when connector 200 is pushed thereon and covers the exposed center conductor of the coaxial cable carrying electrical signal, thereby providing further shielding and protection against signal leakage, even if connector 200 has not been threaded onto the mating port. In the second embodiment, touch component 250 is preferably a touch ring coupled to the end 206 of the post 204. The post end 206 is designed to accommodate the back of touch ring 250. The front of the touch ring 250 contacts that mating port when connector 200 is engaged therewith.

FIG. 10 illustrates a coaxial cable connector 300 according to yet another embodiment of the present invention which is similar to connector 200, except the spring 340 is positioned outside of and generally adjacent to the end 306 of the post 304. Like the embodiments above, connector 300 includes a nut 310 with first and inner second sections 312 and 314 having grounding member 120 and internal threads 130, respectfully, for coupling to the mating port 10.

A conductive touch component 350 is located generally inside of the second inner section 314 of nut 310. Touch component 350 preferably has an abutment surface 352 that contacts the spring 340 such that spring 340 applies a biasing force to touch component 350, particularly when connector 300 is coupled to the mating port. The touch component 350 contacts the mating port 10, and conductive surface thereof, when connector 300 is pushed and covers the exposed center conductor of the coaxial cable carrying electrical signal thereon, thereby providing further grounding and shielding and protection, even if connector 300 has not been threaded onto the mating port. In a preferred embodiment, touch component 350 is a touch pipe in which spring 340 is received therein and abutment surface 352 faces rearwardly from a front wall of touch pipe 350. The end 306 of the post 304 is designed to extend into to the back end of touch pipe 350 such that the touch pipe 350 is coupled to the post end 306.

While particular embodiments have been chosen to illustrate the invention, it will be understood by those skilled in the art that various changes and modifications can be made therein without departing from the scope of the invention as defined in the appended claims.

What is claimed is:

1. A coaxial cable connector, comprising:
a connector body;
a post received at least partially in the connector body, the post being configured to terminate a cable;
a coupling nut having a front end for interfacing with a mating port, an opposite rear end rotatably coupled to the post, and first and second inner sections therebetween, the first inner section being near or at the front end and the second inner section being behind the first inner section, both of the first and second inner sections being configured to engage the mating port; and
a grounding member positioned on an inner surface of the coupling nut at the first inner section, the grounding member being configured for electrical connection to the mating port, thereby establishing a grounding path therebetween.

2. The connector according to claim 1, wherein the first inner section is configured for a push-on engagement with the mating port and the second inner section is configured for a threaded engagement with the mating port.

3. The connector according to claim 2, wherein the second inner section includes threads on the inner surface of the coupling nut for threadably engaging the mating port.

4. The connector according to claim 3, wherein the second inner section includes three threads.

5. The connector according to claim 2, wherein the grounding member is a conductive spring member with radial flexibility that is configured to provide a friction fit when engaging the mating port.

6. The connector according to claim 5, wherein the conductive spring member is a spring strip positioned along the inner surface of the coupling nut at the first inner section forming a generally ring shape.

7. The connector according to claim 6, wherein the conductive spring strip has inner and outer faces and comprises at least one contact point on the inner face of the spring strip for contacting a conductive surface of the mating port.

8. The connector according to claim 7, wherein the conductive spring strip comprises at least one beam extending between frame ends, the at least one beam having the at least one contact point.

9. The connector according to claim 8, wherein the conductive spring strip comprises a plurality of beams extending between the frame ends and a plurality of contact points, each of the beams having at least one of the plurality of contact points.

10. The connector according to claim 8, wherein the at least one beam has a concave shape curving away from the inner surface of the coupling nut.

11. The connector according to claim 8, wherein the at least one beam has one or more concave portions extending inwardly away from the inner surface of the coupling nut, each of the one or more concave portions having at least one of the contact points.

12. The connector according to claim 8, wherein the at least one beam is substantially straight and inset from the frame ends of the conductive spring strip.

13. The connector according to claim 12, wherein the at least one contact point defines a contact surface for engaging the mating port.

14. The connector according to claim 7, wherein the front end of the coupling nut includes an annular lip, the spring strip being captured between the annular lip and a first thread of the threads of the second inner section.

15. A coaxial cable connector, comprising:
a connector body;
a post received at least partially in the connector body, the post being configured to terminate a cable; and
a coupling nut having a front end for interfacing with a mating port, an opposite rear end rotatably coupled to the post, and first and second inner sections therebetween, the first inner section being near or at the front end and configured to push onto the mating port, the first inner section having a grounding member for providing an electrical connection with an outer surface of the mating port, thereby establishing an immediate grounding path when the coupling nut is pushed onto the mating port, and the second inner section being behind the first inner section and configured to threadably engage the mating port,
wherein the grounding member is a conductive spring member with radial flexibility that is configured to provide a friction fit when the coupling nut is pushed onto the mating port.

16. The connector according to claim 15, wherein the conductive spring member is a spring strip positioned along the inner surface of the coupling nut at the first inner section forming a generally ring shape and has inner and outer faces and comprises at least one contact point on the inner face of the spring strip for contacting a conductive surface of the mating port.

17. The connector according to claim 16, wherein the conductive spring strip comprises at least one beam extending between frame ends, the at least one beam having the at least one contact point.

18. The connector according to claim 17, wherein the at least one beam has a concave shape curving away from the inner surface of the coupling nut.

19. The connector according to claim 18, wherein the at least one beam has one or more concave portions extending inwardly away from the inner surface of the coupling nut, each of the one or more concave portions having at least one of the contact points.

20. The connector according to claim 18, wherein the at least one beam is substantially straight and inset from the frame ends of the conductive spring strip.

21. The connector according to claim 15, wherein the second inner section includes three threads.

22. The connector according to claim 15, further comprising a spring disposed between the coupling nut and the post, the spring being configured to compress in a longitudinal direction when the second inner section is threaded onto the mating port.

23. The connector according to claim 22, further comprising a conductive touch component received in the coupling nut, and the spring being positioned to bias the conductive touch component in a mating direction toward the first inner section of the coupling nut.

24. The connector according to claim 23, wherein the conductive touch component includes a mating port contact surface at one end for contacting the mating port when the coupling nut is pushed onto the mating port.

25. The connector according to claim 23, wherein the spring is positioned either outside of the post adjacent to an end of the post or inside of the end of the post.
